(19) United States
(12) Patent Application Publication
(10) Pub. No.: US 2008/0305279 A1
(43) Pub. Date: Dec. 11, 2008

(54) METHOD OF MARKING A SURGICAL ARTICLE

(76) Inventor: Duncan Young, Hebden Bridge (GB)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/929,091

(22) Filed: Oct. 30, 2007

Related U.S. Application Data
(60) Provisional application No. 60/863,596, filed on Oct. 31, 2006.

(51) Int. Cl. B41M 99/00

(52) U.S. Cl. 427/596

(57) ABSTRACT

A method of marking a surgical article is described that includes the steps of providing a surgical article having a surface; engraving a portion of the surface to create an engraved surface; darkening an area of the surface that includes the engraved surface; and removing the marking on that area of the surface that does not include the engraved surface.

### FIELD OF THE INVENTION

This invention relates to a surgical article and a method for making a surgical article having one or more identification marks that function to identify information about the article, such as color, size, catalog number and the like, or are used as intra-operative indicia such as angle markings, scale markings or graduated scales.

### DESCRIPTION OF THE RELATED ART

Surgical articles, such as devices and instruments, often bear a number of identification markings that serve various purposes. Often the articles bear identification markings that identify, for example, the article product code, serial numbers or batch/lot codes, size, weight or volume of the article, the name of the article, or the name of the manufacturer, etc. The article may also include markings that facilitate the use of the article during a surgical procedure such as angle markings, scale markings or graduated scales.

Because surgical articles are washed and sterilized after use, it is desirable to mark markings directly on the surface of the surgical articles. Moreover, the shapes of surgical articles are not uniform and portions in which markings are created are not always flat. Accordingly, the markings must be created by a method that does not require the article to be flat, yet in a manner that permits the markings to be read regardless of the shape of the surface.

In the past, those skilled in the art have engraved or etched markings on surgical articles. However, these methods are not optimal as both engraved markings and laser markings are not always easy to read, especially under poor lighting conditions. In addition, laser markings can wear off due to abrasion, can cause article discoloration, and is difficult to control from a batch-process perspective.

Those skilled in the art have also attempted to fill engraved markings with a colored epoxy to make it more readable. The method of filling the engravings with epoxy is not easily controlled, however, and the epoxy-stainless-steel bond often fails.

It is therefore desirable to provide markings for a surgical article that are easy to read, yet durable enough to survive multiple sterilization processes, and relatively inexpensive to manufacture.

### SUMMARY OF THE INVENTION

The present invention provides a surgical article that has a surface. The surface of the article has markings that have been formed by engraving. As a result, the engraved surfaces do not lie on the same plane as the remaining surfaces of the article. The engraved surfaces are darkened by oxidizing the engraved surfaces by either a chemically marking, laser marking, or another oxidation process.

A method of manufacturing a surgical article is also provided. The method includes the steps of providing a surgical article having a surface; engraving a portion of the surface to create an engraved surface; darkening an area of the surface that includes the engraved surface; and removing the darkening on that area of the surface that does not include the engraved surface.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIGS. 1A-1C are perspective views of the sequence of steps of the process of enhancing marking on a representative surgical articles; and

FIG. 2 is a plan view of a representative surgical article having enhanced marking contrast.

### DETAILED DESCRIPTION

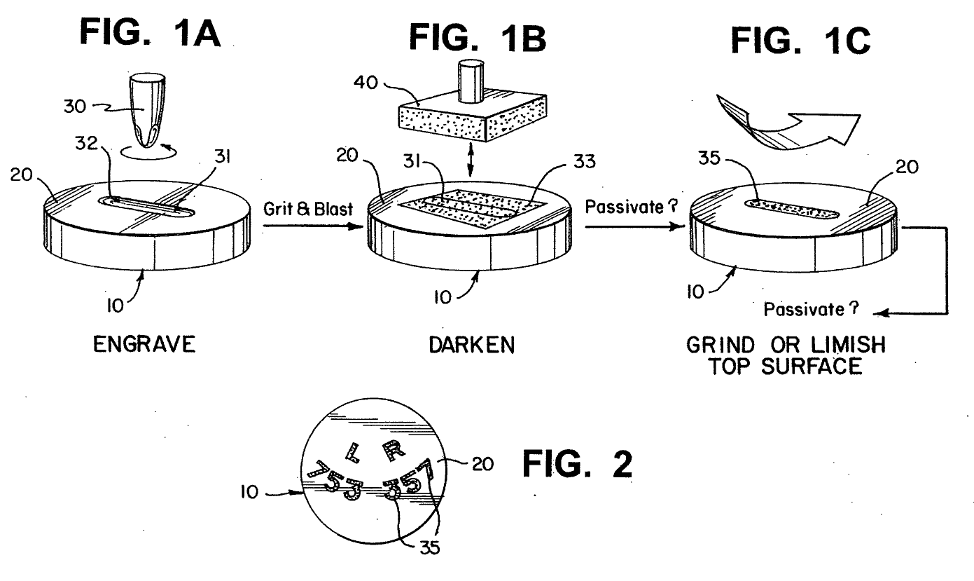

Referring now to FIGS. 1A through 1C the process of creating a marking on a surgical article, generally referred to as reference numeral 10, is depicted. Surgical article 10 can be an implant that is left in the body at the completion of surgery or it can be a surgical instrument or device for use in facilitating the surgical procedure. By way of non-limiting example, an implant can be a component of a shoulder, knee or hip implant, a spinal cage, a plate, or any other device that one can leave within a body. Also by way of non-limiting example, surgical instruments or devices can include cutting blocks, rasps, reamers, drills, scissors, cutters, graspers, staple applicators, clip applicators, laser devices, viewing (optical) devices, illuminating devices, and any combination of these. Typically, surgical article 10 is formed of a metal. In some embodiments, surgical article 10 can be formed of stainless steel.

As is shown in FIG. 1A, Article 10 has a surface 20 upon which a marking is to be formed. Surface 10 is shown as a flat surface but it may be curved or any combination of different types of surfaces. The first step in the method of marking surgical article 10 is to use an engraver 30 to engrave an engraved surface 31 in surface 20. Engraved surface 31 does not lie in the same plane as the surfaces adjacent to engraved surface 31. As a result, engraved surface has a three dimensional component defined by the amount of material removed during the engraving step. Engraved surface 31 has a depth relative to surface 20, and thus has side walls and a bottom surface. In the depicted embodiment, engraved surface 31 is shown as a straight line. Optionally, article 10 is grit blasted to remove any sharp edges and to clean surface 20 and engraved surface 31.

In the next step, depicted in FIG. 1B, engraved surface 31 and an area preferably surrounding engraved surface 31, hereinafter referred to as area 33, are treated to darkening area 33 and engraved surface 31 by a darkening device shown as reference numeral 40. Area 33 can be darkened in a number of ways without without filling engraved surface 31 with a colored or black liquid. Among the known methods, one can laser mark area 33, black oxidize area 33 or chemically etch area 33. In each case, area 33 of surface 20 is treated with a process known in the art to darken area 33. While darkening device 40 is depicted as a pad that might be used to deliver a chemical or an oxidizing agent, it is understood that it may be any device used by one skilled in the art to darken a surface, including a laser.

Finally, as is shown in FIG. 1C, that part of area 33 that is not engraved surface 31 is treated to remove the darkening, thereby leaving engraved surface 31 as the darkened portion of surface 20. The darkening may be removed by a limishing or polishing or grinding step, for example, to remove the darkening. In either case, as little as the top few microns of surface 20 are removed, but in any event a thickness that removes that portion of surface 20 that was darkened during the darkening step or at least lightens the darkened portion of surface 20 relative to the darkened engraved surface 35.

Optionally, surface 20, including engraved surface 31 may be passivated at any point during the process or at multiple points during the process.

In this manner engraved surface 31 is darkened relative to the surrounding surface area to leave a darkened engraved surface shown as 35 in FIG. 1C. As a result, the contrast of the darkened marking with the surrounding surface area is increased, thereby making the marking more readable at all angles and under different lighting conditions. Furthermore, the combination of steps produces a darkened marking that will survive even if article 10 is subjected to multiple sterilization processes.

An example of the resulting article 10 with a darkened engraved surface 35 is shown in FIG. 2. That figure shows that surface 20 is engraved in text that reads “L 753” and R 357”. The contrast between the text of article 10 and the area surrounding the text is enhanced by the darkening as compared with text that had no darkening.

Although illustrative embodiments of the present invention have been described herein with reference to the accompanying drawings, it is to be understood that the invention is not limited to those precise embodiments and that various other changes and modifications may be effected herein by one skilled in the art without departing from the scope or spirit of the invention.

What is claimed is:

1. A method of marking a surgical article, comprising the steps of:
providing a surgical article having a surface;
engraving a portion of the surface to create an engraved surface;
darkening an area of the surface that includes the engraved surface; and
removing the darkening on that area of the surface that does not include the engraved surface.

2. The method of claim 1, wherein the marking step comprises the step of darkening the area without filling the engraved surface with a colored liquid.

3. The method of claim 1, wherein the marking step comprises the step of oxidizing the area.

4. The method of claim 3, wherein the step of oxidizing comprises laser marking the area.

5. The method of claim 3, wherein the step of oxidizing comprises black oxidizing the area.

6. The method of claim 3, wherein the step of oxidizing comprises chemically etching the area.

7. The method of claim 1, wherein the removing step comprises removing a layer of that area of the surface that does not include the engraved surface.

8. The method of claim 7, wherein the removing step comprises grinding a layer of that area of the surface that does not include the engraved surface.

9. The method of claim 7, wherein the removing step comprises linishing that area of the surface that does not include the engraved surface.

10. The method of claim 1, further comprising the step of passivating the area of the surface that includes the engraved surface.

11. The method of claim 1, further comprising the step of grit blasting the surgical article following the etching step.

12. A surgical article having a surface, the surface having engraved markings darkened by oxidizing the engraved surfaces.
